(19) United States
(12) Patent Application Publication
(10) Pub. No.: US 2010/0193689 A1
(43) Pub. Date: Aug. 5, 2010

(54) INFRARED SIGNAL-RECEIVING UNIT AND ELECTRONIC DEVICE

(76) Inventor: Masashi Yokota, Osaka-shi (JP)

Correspondence Address: BIRCH STEWART KOLASCH & BIRCH, PO BOX 747, FALLS CHURCH, VA, 22040-0747, US

(21) Appl. No.: 12/676,278

(22) PCT Filed: Jun. 13, 2008
(86) PCT No.: PCT/JP2008/060885

§ 371 Date: Mar. 3, 2010

(30) Foreign Application Priority Data
Sep. 4, 2007 (JP) 2007-229305

(51) Int. Cl. G01J 5/02

(52) U.S. Cl. 250/353

(57) ABSTRACT

The present invention provides an infrared signal-receiving unit and an electronic device each capable of suppressing malfunction and communication failures of infrared communication equipment. The present invention is an infrared signal-receiving unit comprising a light guide and an infrared receiver that receives an infrared signal guided by the light guide,
wherein the unit includes a multi-layer reflective film that reflects infrared at a wavelength band corresponding to that of disturbing light, and the infrared receiver receives the infrared signal that has passed through the multi-layer reflective film.

### TECHNICAL FIELD

The present invention relates to an infrared signal-receiving unit and an electronic device. More particularly, the present invention relates to an infrared signal-receiving unit and an electronic device, mounted on a television (TV), digital versatile disc (DVD) equipment, a video tape recorder (VTR), an air-conditioner, etc.

### BACKGROUND ART

Infrared signal-receiving units, which receive an infrared signal transmitted from infrared signal-transmitting units, such as an infrared remote controller, includes an infrared receiver such as a photo diode chip, and this infrared receiver receives the infrared signal. Then, the received infrared signal undergoes various kinds of processing such as amplification and waveform shaping executed by a signal controller. In response to this signal, a TV, a DVD, a VTR, an air-conditioner, etc., can be remote-controlled.

Such an infrared signal transmitted from the infrared signal-transmitting unit is a digital signal. The infrared signal is received by a receiving surface of a photo diode chip to be converted into a weak electrical signal. From this weak electrical signal, only a signal with a specific frequency band is extracted by a filter circuit (band-pass filter). Then, this extracted signal is output by a detector circuit, as the same digital waveform information as the infrared signal.

Preferably, the infrared signal-receiving unit is mounted at a front face of equipment such as a TV and DVD equipment in order to efficiently receive the infrared signal transmitted from the infrared signal-transmitting unit. Further, it is preferable that the infrared receiver is also located at the back of the front face of the equipment in order to reduce influences of disturbing light, which causes malfunction of the equipment. So the equipment such as a TV and DVD equipment is so configured that a light guide is arranged from the front face of the equipment to the infrared receiver, thereby guiding an infrared signal having entered the front face of the equipment to the receiving surface of the infrared receiver.

As such a light guide-including infrared signal-receiving unit, for example, Patent Document 1 discloses the following remote control light-receiving unit. A light guide is arranged so that at least a part of a terminating end thereof which guides a received signal light to a lens portion that condenses the light to photoelectric conversion means) is attached tightly to the lens portion, thereby improving a transmission efficiency of the transmitting signal light guided from the light guide to the lens portion.

Further, for example, Patent Document 2 discloses a remote control light receiver composed of the following components: an electronic circuit board including a light receiver for receiving an infrared signal transmitted from a remote control; a case housing the circuit board therein, made of a conductive material; a front plate attached to the case; and a waveguide. This waveguide includes a transparent plate with infrared-transmitting properties (possibly having a shape with Fresnel lens mechanism) attached to the front plate. Further, the waveguide is arranged in an opening of the front plate so that an infrared signal having passed through the transparent plate is condensed to the light receiver.

### [Patent Document 1]

Japanese Kokai Publication No. 2006-179767

### [Patent Document 2]

Japanese Kokai Publication No. 2004-320304

### DISCLOSURE OF INVENTION

The size of liquid crystal display displays, which are popularly used now, is growing. Along with this, its screen also becomes larger. When such a liquid crystal display including a large screen is started up, malfunction of infrared communication equipment such as an infrared remote control and DVD equipment might be generated, or an infrared remote control might not be worked well. Particularly in a liquid crystal TV including CCFTs (cold cathode fluorescent tubes) as a light source of a backlight, infrared in a specific wavelength band different depending on a composition of gas discharged inside the CCFT is radiated from the CCFT for several tens of seconds to several minutes after the CCFTs are turned on. This often causes malfunction of infrared communication equipment or communication failures.

The present invention has been made in view of the above-mentioned state of the art. The present invention has an object to provide an infrared signal-receiving unit and an electronic device each capable of suppressing malfunction and communication failures of infrared communication equipment.

The inventor made various investigations on an infrared signal-receiving unit capable of suppressing malfunction and communication failures of infrared communication equipment. The inventor found that a signal-to-noise ratio (hereinafter, also referred to as a “S/N ratio”) of an infrared receiver is decreased if a wavelength band of light to which the infrared receiver of the unit has a high selectivity and a wavelength band of disturbing infrared radiated from a backlight of a liquid crystal display device and the like overlap with each other. Then, the inventor noted, as means for improving the S/N ratio of the infrared receiver, reflection characteristics of a multi-layer reflective film, capable of selectively showing a high reflectance in a narrow wavelength band. As a result, the inventor found that the S/N ratio of the infrared receiver can be improved if the infrared signal-receiving unit has the following configuration: a multi-layer reflective film that reflects infrared at a wavelength band corresponding to that of disturbing light is provided with the unit, and the infrared receiver receives an infrared signal the film has transmitted. This is because, in this configuration, the disturbing infrared is reflected by the multi-layer reflective film without reaching the receiver, and an infrared signal in other wavelength bands reaches the receiver without being reflected by the multi-layer reflective film. As a result, the above-mentioned problems have been admirably solved, leading to completion of the present invention.

That is, the present invention is an infrared signal-receiving unit comprising alight guide and an infrared receiver that receives an infrared signal guided by the light guide,

wherein the unit includes a multi-layer reflective film that reflects infrared at a wavelength band corresponding to that of disturbing light, and the infrared receiver receives the infrared signal that has passed through the multi-layer reflective film.

The invention is mentioned in detail below.

The infrared signal-receiving unit of the present invention includes a light guide and an infrared receiver that receives an infrared signal guided by the light guide. The infrared signal-receiving unit of the present invention is mounted on a TV, DVD equipment, a VTR, an air-conditioner, and the like to receive an infrared signal transmitted from the infrared signal-transmitting unit. The infrared receiver is usually located at the back of a front face of equipment on which the unit is mounted in order to prevent malfunction caused by disturbing light. So the light guide is arranged over the front face of the equipment to the receiving surface of the infrared receiver in order to efficiently guide the infrared signal to the receiving surface of the infrared receiver. A light exiting surface of the light guide may or may not be in contact with the receiving surface of the infrared receiver.

The light guide is not especially limited as long as it can transmit infrared, and it may or may not transmit visible light. The infrared receiver is not especially limited as long as it converts an infrared signal to an electric signal. A photo diode and the like may be mentioned as the infrared receiver. The photodiode is a photoelectric conversion element that converts light into an electric charge by utilizing an increase in reverse current which flows through p-n semiconductor junction or metal-semiconductor rectifying contact by photovoltaic effect generated by photo-irradiation. A light source of the infrared signal-transmitting unit is not especially limited, and an infrared emitting diode may be mentioned as the light source. The infrared emitting diode is a semiconductor device having semiconductor junction where infrared radiant flux is generated without heat when a current flows by voltage application.

The above-mentioned infrared signal-receiving unit includes a multi-layer reflective film that reflects infrared at a wavelength band corresponding to that of disturbing light, and the receiver receives an infrared signal the multi-layer reflective film has transmitted. Attributed to the multi-layer reflective film arranged in the unit, the disturbing infrared does not reach the receiver and infrared in the other wavelength band can reach the receiver. Thus, the S/N ratio can be increased. As a result, malfunction and communication failures of infrared communication equipment can be suppressed, and the sensitivity of the unit is improved, and as a result, even remote exchange of infrared signals can be smoothly achieved.

The “disturbing light” and “disturbing infrared” in the present description mean light (infrared) that enters the unit from outside thereof and disturbs normal operation or equilibrium state of the unit. Whether light that enters the unit is the “disturbing light (infrared)” or not depends on light-receiving sensitivity of the receiver. It is preferable that the multi-layer reflective film reflects 50% or larger of infrared for which the receiver shows a high sensitivity. Such a disturbing infrared is radiated by, for example, light sources (CCFT (CCFL)) of a backlight of a liquid crystal TV, HCFTs (HCFL), semi-hot cathode fluorescent tubes (SHCFT), external electrode fluorescent lamps (EEFL), mercury-less lamps, and the like.

The “multi-layer reflective film” in the present description is a reflective film composed of two or more layers stacked one above the other. The number of the layers constituting the film is not especially limited as long as it is two or larger. An embodiment in which a transparent film with a high reflectance and a transparent film with a low reflectance are alternately stacked is mentioned, as a preferable embodiment of the multi-layer reflective film.

FIG. 7 is a graph showing a relationship among the following spectrums: a light-receiving sensitivity spectrum of the infrared receiver (A in FIG. 7), an intensity spectrum of infrared signal (hereinafter, also referred to as “infrared B”) transmitted by the infrared signal-transmitting unit (B in FIG. 7), an intensity spectrum of infrared (hereinafter, also referred to as “infrared C”) the multi-layer reflective film can reflect of the infrared B (C (shaded part) in FIG. 7), an intensity spectrum of infrared (hereinafter, also referred to as “infrared D”) the receiver can receive of the infrared ray B (D in FIG. 7), and an intensity spectrum of disturbing infrared (hereinafter also referred to as “infrared E”) (E (black part) in FIG. 7). The present invention is not especially limited to the relationship in FIG. 7. For example, the wavelength band of the infrared B does not need to be within that of the infrared A, and each of the infrared D and the infrared E may have plural and separated peaks.

The light-receiving sensitivity of the receiver depends on light-receiving sensitivity of silicon if the infrared receiver is a silicon photo-diode. The intensity spectrum of the infrared B depends on light-emitting characteristics of a light source of the infrared signal-transmitting unit. The intensity spectrum of infrared C depends on the reflection characteristics of the multi-layer reflective film and it can be easily adjusted by controlling the reflectance and the thickness of the multi-layer reflective film. The intensity spectrum of the infrared D is defined by subtracting that of the infrared C from that of the infrared B. The infrared E is disturbing light and it is usually infrared whose wavelength band is within a wavelength band where the infrared receiver has a high sensitivity and which enters the unit from the outside.

In the present invention, in order to decrease disturbing light entering the receiver, the reflectance and thickness of the multi-layer reflective film need to be controlled so that the wavelength band of the disturbing infrared E corresponds to that of the infrared C but not overlap with the wavelength band of the infrared D. In order to increase the intensity of the infrared signal the receiver receives, the wavelength band of the infrared D needs to be within a wavelength band where the receiver has a high sensitivity, and the infrared D needs to have a wide wavelength band.

The infrared signal-receiving unit of the present invention is not especially limited as long as it includes the light guide, the infrared receiver, and the multi-layer reflective film, mentioned above. The unit may or may not include other components.

Preferable embodiments of the infrared signal-receiving unit of the present invention are mentioned below.

The preferable embodiment of the multi-layer reflective film includes an embodiment in which the multi-layer reflective film reflects infrared at 912 nm. Fluorescent tubes such as CCFT are typically used as a light source of a backlight provided in a liquid crystal TV, and the like, and such tubes include argon and mercury discharged therein. In an initiate stage of lighting, when a wall temperature of the tube is low, a mercury vapor pressure inside the tube is not sufficiently increased and light-emission of Ar is increased. As a result, infrared at 912 nm, in addition to visible ray, is radiated. When the receiver detects such infrared at 912 nm, malfunction and communication failures of infrared communication equipment might be caused. For example, IrSS (Ir simple shot) (registered trademark)-compliant high-speed infrared communication begins to be used in digital cameras or cellular phones, and these IrSS-compliant equipments might misrecognize the infrared at 912 nm as a signal. According to the present invention, the infrared at 912 nm is reflected by the multi-layer film before reaching the infrared receiver. As a result, malfunction and communication failures of infrared communication equipment can be effectively suppressed.

According to another preferable embodiment of the multi-layer film, the multi-layer reflective film reflects at least one of infrared at 878 nm and infrared at 893 nm. As a way of reducing the infrared communication failures that are generated in the early stage of lighting of the CCFT, discharge of krypton gas together with argon gas into the CCFT is mentioned. According to this way, in the early stage of lighting of the CCFT, light with a narrow bandwidth, emitted by krypton gas can be emitted instead of light with a wide bandwidth, emitted by argon gas. So use of an infrared absorbing sheet allows effective suppression of the intensity of infrared radiated from the CCFT. However, infrared which is derived from light emitted by krypton gas and which the sheet can not absorb, might be radiated. In view of this, the multi-layer reflective film that reflects at least one, preferably both of infrared with 878 nm and infrared with 893 nm, each intensity of which being particularly high of light emitted by krypton gas, is arranged in the infrared signal-receiving unit. As a result, malfunction and communication failures of infrared remote control, caused by the infrared, can be effectively suppressed.

According to another preferable embodiment of the unit of the present invention, the infrared receiver has a planar receiving surface, and on the planar receiving surface, the multi-layer reflective film is arranged. The multi-layer reflective film shows a relatively high reflectance to light with a narrow bandwidth compared with metals, but the reflectance significantly varies depending on an incident angle of the light. The receiving surface of the infrared receiver is formed into a planar shape although it is conventionally a hemispherical shape so as not to show directivity. Further, the multi-layer reflective film is provided on the receiving surface, and thereby infrared at a wavelength band corresponding to that of disturbing light can be effectively reflected.

If the multi-layer reflective film is arranged on the planar receiving surface of the receiver, preferable embodiments of the light guide include an embodiment in which the light guide converts the infrared at a wavelength band corresponding to that of disturbing light into parallel ray traveling in a direction vertical to a surface of the multi-layer reflective film at least one of a light-entering surface and a light-exiting surface of the light guide. According to such an embodiment, the multi-layer reflective film can more effectively reflect the disturbing infrared. The following embodiments are mentioned, for example, as an embodiment of the light guide that converts the infrared into the parallel light beam. At least one of the light-entering surface and the light-exiting surface has a prism shape; or at least one of the light-entering surface and the light-exiting surface has a convex lens shape. A shape composed of plural pyramids like a triangular or quadrangular pyramid or composed of plural circular cones is mentioned as the prism shape. As the convex lens shape, for example, a shape that is formed by arranging plural hemispherical surfaces is mentioned. It is preferable in view of conversion efficiency into the parallel light beam that the light guide converts the infrared into the parallel light beam at its light-exiting surface.

According to another preferable embodiment of the infrared signal-receiving unit of the present invention, the light guide has a planar light-exiting surface and,

on the planar light-exiting surface, the multi-layer reflective film is arranged. According to this, a multi-layer reflective film-air interface and a light guide-air interface do not exist, whereby the infrared at a wavelength band corresponding to that of disturbing light can be effectively reflected.

According to another preferable embodiment of the infrared signal-receiving unit of the present invention, the infrared receiver has a concave light-receiving surface, and

on the concave light-receiving surface, the multi-layer reflective film is arranged. According to this, the infrared at a wavelength band corresponding to that of disturbing light can be effectively reflected without converting it into a parallel light beam at the light-exiting surface of the light guide.

The present invention is also an electronic device including the infrared signal-receiving unit. According to an electronic device of the present invention, malfunction and communication failures are prevented. The kind of the electronic device is not especially limited, a TV, DVD equipment, a VTR, an air-conditioner, etc. are mentioned.

### EFFECT OF THE INVENTION

According to the infrared signal-receiving unit of the present invention, the multi-layer reflective film can reflect the infrared at a wavelength band corresponding to that of disturbing light whereby malfunction and communication failures of infrared communication equipment can be effectively suppressed.

### BEST MODES FOR CARRYING OUT THE INVENTION

The present invention is mentioned in more detail below with reference to Embodiments, but not limited to only these Embodiments.

### Embodiment 1

FIG. 1 is a cross-sectional view schematically showing a configuration of an infrared signal-receiving unit mounted on a liquid crystal TV in accordance with Embodiment 1.

An infrared signal-receiving unit 100a includes a light guide 10a and a silicon photo-diode chip (infrared receiver) 11a that receives an infrared signal guided by the light guide 10a. The light guide 10a has a cylindrical body with a diameter of about 5 mm. Further, the light guide 10a is attached to a cabinet 20a (casing of the liquid crystal TV) so that its light-entering surface is attached thereto and its planar light-exiting surface 1a faces a receiving surface 2a of the chip 11a with a distance of several millimeters therebetween. The receiving surface 2a of the chip 11a has a hemispherical shape. The chip 11a is mounted on a pedestal 21a. In the present Embodiment, the multi-layer reflective film 30a is arranged on the hemispherical receiving surface 2a of the chip 11a.

Examples of the material for the light guide 10a include thermoplastic resins such as polycarbonate and acrylic resin and thermosetting resins such as epoxy resin. The multi-layer reflective film 30a are composed of two or more layers such as a dielectric film and a metal vapor deposition film, stacked one above another. Resins such as polyethylene terephthalate (PET) are mentioned as a material for the dielectric film. The multi-layer reflective film 30a may be arranged on the receiving surface 2a of the chip 11a by directly vapor-depositing the material thereon or by vapor-depositing the material on a base film and attaching the film to the surface 2a of the chip 11a. The multi-layer reflective film 30a has a property of reflecting 50% or higher of infrared at 913±10 nm and infrared at 1015±10 nm. The infrared at 913±10 nm and the infrared at 1015±10 nm are radiated with a high intensity in the early stage of lighting of a backlight of the liquid crystal TV when light is emitted by argon gas discharged into the CCFTs. This emitted light has a narrow wavelength band, and so it is preferable that the multi-layer reflective film 30a shows the reflecting property in a narrow wavelength band and shows a high reflectance to light in such a narrow wavelength band. Further, the multi-layer reflective film 30a may have a property of reflecting light at 966±10 nm.

According to the unit 100a of the present Embodiment, the disturbing infrared radiated from the backlight of the liquid crystal TV is reflected by the multi-layer reflective film 30a, failing to reach the chip 11a. at least a part of infrared signal, which is transmitted from a infrared signal transmitter such as an infrared remote control and an IrSS-compliant device reaches the chip 11a without being reflected by the film 30a. Thus, the S/N ratio of the chip 11a can be improved, and as a result, malfunction of the liquid crystal TV can be suppressed.

### Embodiment 2

FIG. 2 is a cross-sectional view schematically showing a configuration of an infrared signal-receiving unit mounted on a liquid crystal TV in accordance with Embodiment 2.

An infrared signal-receiving unit 100b includes a light guide 10b and a silicon photo-diode chip (infrared receiver) 11b that receives an infrared signal guided by the light guide 10b. The light guide 10b has a cylindrical body with a diameter of about 5 mm. Further, the light guide 10b is attached to a cabinet 20b (casing of the liquid crystal TV) so that its light-entering surface is attached thereto and its planar light-exiting surface 1b faces a receiving surface 2b of the chip 11b with a distance of several millimeters therebetween. The receiving surface 2b of the chip 11b has a planar shape. The chip 11b is mounted on a pedestal 21b. In the present Embodiment, the multi-layer reflective film 30b is arranged on the planar receiving surface 2b of the chip 11b.

According to the unit 100b of the present Embodiment, most of the disturbing infrared vertically enters the surface of the film 30b to be effectively reflected by the film 30b. Thus, the S/N ratio of the chip 11b can be improved, and as a result, malfunction of the liquid crystal TV can be suppressed.

### Embodiment 3

FIG. 3 is a cross-sectional view schematically showing a configuration of an infrared signal-receiving unit mounted on a liquid crystal TV in accordance with Embodiment 3.

An infrared signal-receiving unit 100c includes a light guide 10c and a silicon photo-diode chip (infrared receiver) 11c that receives an infrared signal guided by the light guide 10c. The light guide 10c has a cylindrical body with a diameter of about 5 mm. Further, the light guide 10c is attached to a cabinet 20c (casing of the liquid crystal TV) so that its light-entering surface is attached thereto and its prism-shaped (like a shape formed by arraying plural quadrangular pyramids) light-exiting surface 1c faces a receiving surface 2c of the chip 11c with a distance of several millimeters therebetween. The receiving surface 2c of the chip 11c has a planar shape. The chip 11c is mounted on a pedestal 21c. In the present Embodiment, the multi-layer reflective film 30c is arranged on the planar receiving surface 2c of the chip 11c.

According to the unit 100c of the present Embodiment, the disturbing infrared is converted into a parallel light beam traveling in a direction vertical to the surface of the film 30c by the prism-shaped light-exiting surface 1c of the light guide 1c, and then effectively reflected by the film 30c. Thus, the S/N ratio of the chip 11c can be improved, and as a result, malfunction of the liquid crystal TV can be suppressed.

### Embodiment 4

FIG. 4 is a cross-sectional view schematically showing a configuration of an infrared signal-receiving unit mounted on a liquid crystal TV in accordance with Embodiment 4.

An infrared signal-receiving unit 100d includes a light guide 10d and a silicon photo-diode chip (infrared receiver) 11d that receives an infrared signal guided by the light guide 10d. The light guide 10d has a cylindrical body with a diameter of about 5 mm. Further, the light guide 10d is attached to a cabinet 20d (casing of the liquid crystal TV) so that its light-entering surface is attached thereto and its convex lens-shaped (like a shape formed by arraying plural hemispheres) light-exiting surface 1d faces a receiving surface 2d of the chip 11d with a distance of several millimeters therebetween. The receiving surface 2d of the chip lid has a planar shape. The chip lid is mounted on a pedestal 21d. In the present Embodiment, the multi-layer reflective film 30d is arranged on the planar receiving surface 2d of the chip 11d.

According to the unit 100d of the present Embodiment, the disturbing infrared is converted into a parallel light beam traveling in a direction vertical to the surface of the film 30d by the convex lens-shaped light-exiting surface 1d of the light guide 1d, and then effectively reflected by the film 30d. Thus, the S/N ratio of the chip lid can be improved, and as a result, malfunction of the liquid crystal TV can be suppressed.

### Embodiment 5

FIG. 5 is a cross-sectional view schematically showing a configuration of an infrared signal-receiving unit mounted on a liquid crystal TV in accordance with Embodiment 5.

An infrared signal-receiving unit 100e includes a light guide 10e and a silicon photo-diode chip (infrared receiver) lie that receives an infrared signal guided by the light guide 10e. The light guide 10e has a cylindrical body with a diameter of about 5 mm. Further, the light guide 10e is attached to a cabinet 20e (casing of the liquid crystal TV) so that its light-entering surface is attached thereto and its planar light-exiting surface 1e faces a receiving surface 2e of the chip lie with a distance of several millimeters therebetween. The receiving surface 2e of the chip 11e has a hemispherical shape. The chip 11e is mounted on a pedestal 21e. In the present Embodiment, the multi-layer reflective film 30e is arranged on the planar light-exiting surface 1e of the light guide 10e.

According to the unit 100e of the present Embodiment, an interface between the film 30e and air and an interface between the light guide 10e and air, existing between the light guide 10e and the film 30e, do not exist, so the infrared at a wavelength band corresponding to that of disturbing light can be effectively reflected. Thus, the S/N ratio of the chip 11e can be improved, and as a result, malfunction of the liquid crystal TV can be suppressed.

### Embodiment 6

FIG. 6 is a cross-sectional view schematically showing a configuration of an infrared signal-receiving unit mounted on a liquid crystal TV in accordance with Embodiment 6.

An infrared signal-receiving unit 100f includes a light guide 10f and a silicon photo-diode chip (infrared receiver) 11f that receives an infrared signal guided by the light guide 10f. The light guide 10f has a cylindrical body with a diameter of about 5 mm. Further, the light guide 10f is attached to a cabinet 20f (casing of the liquid crystal TV) so that its light-entering surface is attached thereto and its planar light-exiting surface 1f faces a light-receiving surface 2f of the chip 11f with a distance of several millimeters therebetween. The light-receiving surface 2f of the chip 11f has a concave shape. The chip 11f is mounted on a pedestal 21f. In the present Embodiment, the multi-layer reflective film 30f is arranged on the concave-shaped light-receiving surface 2f of the chip 11f.

According to the unit 100f of the present Embodiment, the disturbing infrared vertically enters the surface of the film 30f to be effectively reflected by the film 30f. Thus, the S/N ratio of the chip 11f can be improved, and as a result, malfunction of the liquid crystal TV can be suppressed.

Although the infrared signal-receiving units in accordance with Embodiments 1 to 6 are mounted on the liquid crystal TV, equipment on which the unit of the present invention is mounted is not especially limited thereto and may be DVD equipment (DVD recorder), VTRs, air-conditioners, etc.

The present application claims priority to Patent Application No. 2007-229305 filed in Japan on Sep. 4, 2007 under the Paris Convention and provisions of national law in a designated State, the entire contents of which are hereby incorporated by reference.

### BRIEF DESCRIPTION OF DRAWINGS

FIG. 1 is a cross-sectional view schematically showing a configuration of an infrared signal-receiving unit mounted on a liquid crystal TV in accordance with Embodiment 1.

FIG. 2 is a cross-sectional view schematically showing a configuration of an infrared signal-receiving unit mounted on a liquid crystal TV in accordance with Embodiment 2.

FIG. 3 is a cross-sectional view schematically showing a configuration of an infrared signal-receiving unit mounted on a liquid crystal TV in accordance with Embodiment 3.

FIG. 4 is a cross-sectional view schematically showing a configuration of an infrared signal-receiving unit mounted on a liquid crystal TV in accordance with Embodiment 4.

FIG. 5 is a cross-sectional view schematically showing a configuration of an infrared signal-receiving unit mounted on a liquid crystal TV in accordance with Embodiment 5.

FIG. 6 is a cross-sectional view schematically showing a configuration of an infrared signal-receiving unit mounted on a liquid crystal TV in accordance with Embodiment 6.

FIG. 7 is a graph showing a relationship among the following spectrums (A) to (E):

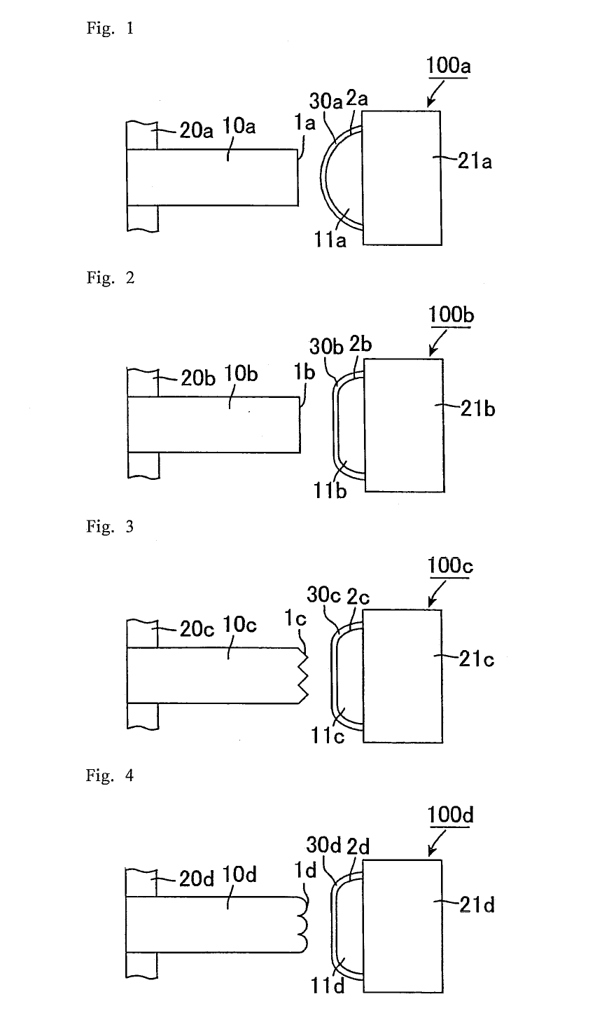

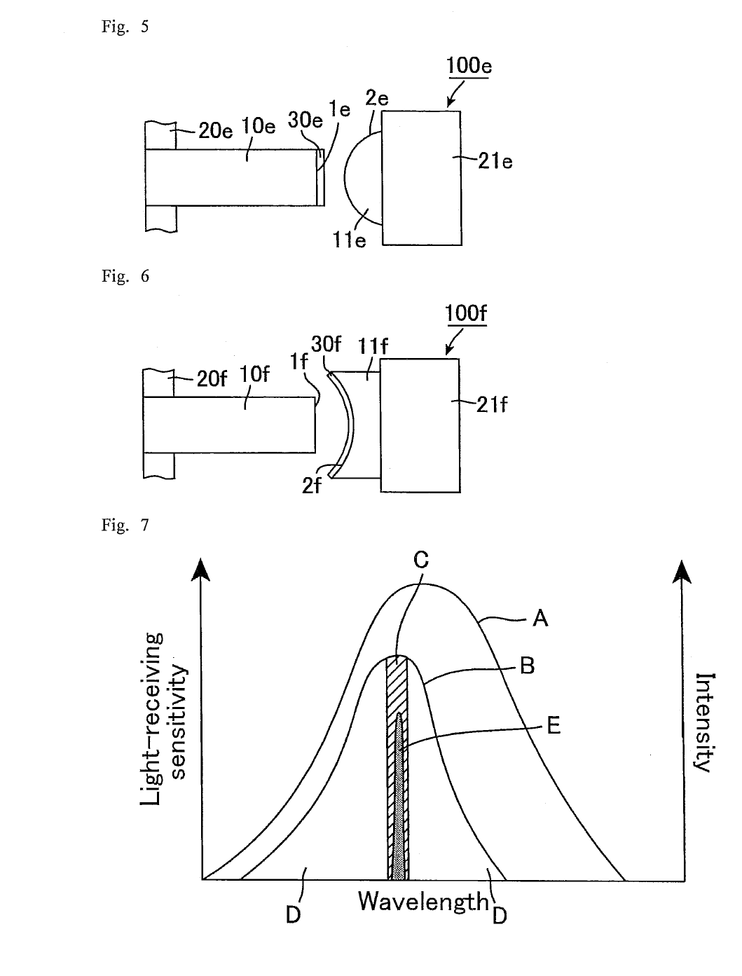

a light-receiving sensitivity spectrum of the infrared receiver (A);

an intensity spectrum of infrared signal transmitted by the infrared signal-transmitting unit (B);

an intensity spectrum of infrared the multi-layer reflective film can reflect (C);

an intensity spectrum of infrared the receiver can receive; and

an intensity spectrum of disturbing infrared (E).

### EXPLANATION OF NUMERALS AND SYMBOLS

1a to 1f: Light-exiting surface of light guide
2a to 2f: Receiving surface of infrared receiver
10a to 10f: Light guide
11a to 11f: Infrared receiver
20a to 20f: Cabinet
21a to 21f: Pedestal
100a to 100f: Infrared signal-receiving unit

1. An infrared signal-receiving unit comprising a light guide and an infrared receiver that receives an infrared signal guided by the light guide,
wherein the unit includes a multi-layer reflective film that reflects infrared at a wavelength band corresponding to that of disturbing light, and the infrared receiver receives the infrared signal that has passed through the multi-layer reflective film.

2. The infrared signal-receiving unit according to claim 1,
wherein the multi-layer reflective film reflects infrared at 912 nm.

3. The infrared signal-receiving unit according to claim 1,
wherein the multi-layer reflective film reflects at least one of infrared at 878 nm and infrared at 893 nm.

4. The infrared signal-receiving unit according to claim 1,
wherein the infrared receiver has a planar receiving surface, and
on the planar receiving surface, the multi-layer reflective film is arranged.

5. The infrared signal-receiving unit according to claim 4,
wherein the light guide converts the infrared at a wavelength band corresponding to that of disturbing light into parallel ray traveling in a direction vertical to a surface of the multi-layer reflective film at least one of a light-entering surface and a light-exiting surface of the light guide.

6. The infrared signal-receiving unit according to claim 5,
wherein at least one of the light-entering surface and the light-exiting surface has a prism shape.

7. The infrared signal-receiving unit according to claim 5,
wherein at least one of the light-entering surface and the light-exiting surface has a convex lens shape.

8. The infrared signal-receiving unit according to claim 1,
wherein the light guide has a planar light-exiting surface and,
on the planar light-exiting surface, the multi-layer reflective film is arranged.

9. The infrared signal-receiving unit according to claim 1,
wherein the infrared receiver has a concave light-receiving surface, and
on the concave light-receiving surface, the multi-layer reflective film is arranged.

10. An electronic device comprising the infrared signal-receiving unit according to claim 1.
